(19) United States
(12) Patent Application Publication
(10) Pub. No.: US 2009/0150126 A1
(43) Pub. Date: Jun. 11, 2009

(54) System and method for sparse gaussian process regression using predictive measures

(75) Inventors: Sundararajan Sellamanickam, Bangalore (IN); Sathiya Keerthi Selvaraj, Cupertino, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 12/001,958

(22) Filed: Dec. 10, 2007

(51) Int. Cl. G06N 7/00

(52) U.S. Cl. 703/2

(57) ABSTRACT

An improved system and method is provided for sparse Gaussian process regression using predictive measures. A Gaussian process regressor model may be construction by interleaving basis vector set selection and hyper-parameter optimization until the chosen predictive measure stabilizes. One of various LOO-CV based predictive measures may be used to find an optimal set of active basis vectors for building a sparse Gaussian process regression model by sequentially adding basis vectors selected using a chosen predictive measure. In a given iteration, a predictive measure is computed for each of the basis vectors in a candidate set of basis vectors and the basis vector with the best predictive measure is selected. The iterative addition of basis vectors may stop when predictive performance of the model degrades or no significant performance improvement is seen.

### FIELD OF THE INVENTION

The invention relates generally to computer systems, and more particularly to an improved system and method for sparse Gaussian process regression using predictive measures.

### BACKGROUND OF THE INVENTION

Gaussian process (GP) regression models are flexible, powerful, and easy to implement probabilistic models that can be used to solve regression problems in many areas of application. See for example C. E. Rasmussen and C. K. I. Williams, Gaussian Processes for Machine Learning, The MIT Press, 2006. For instance, regression problems may arise in applications such as time series prediction of web pages, learning of search page relevance as a function of properties of query and result pages, click through rate prediction, and so forth. While GPs exhibit state of the art performance as a probabilistic tool for regression, they are not used in applications that have large training sets because training time becomes a bottleneck. In particular, GPs suffer from a high computational cost of O(n³) for learning from n samples; further, predictive mean and variance computation on each sample cost O(n) and O(n²) respectively. See J. Q. Candela and C. E. Rasmussen, Analysis of Some Methods for Reduced Rank Gaussian Process Regression, R. Murray-Smith and R. Shorten, editors, Switching and Learning in Feedback Systems, Volume 3355 of Lecture Notes in Computer Science, pages 98-127, Springer, Heidelberg, Germany, 2005a. As a result, the high computational cost limits direct implementation of GPs to problems with few thousands of samples. More importantly, in applications such as search relevance where online function evaluation has to be done very fast, the complexity of the final representation of the GP regressor is also a serious issue.

There have been several approaches proposed to address this concern and build sparse approximate GP models. M. Gibbs and D. J. C. MacKay, Efficient Implementation of Gaussian Processes, Technical Report, Cavendish Laboratory, Cambridge University, Cambridge London, UK, 1997, and C. K. I. Williams and M. Seeger, Using the Nystrom Method to Speed Up Kernel Machines, In Advances in Neural Information Processing Systems, Volume 13, pages 682-688, The MIT Press, 2001, used matrix approximations to reduce the computational cost. V. Tresp, A Bayesian Committee Machine, Neural Computation, 12(11): 2719-2741, 2000, introduced a Bayesian committee machine. L. Csato and M. Opper, Sparse Online Gaussian Process, Neural Computation, 14(3): 641-668, 2002, developed an online algorithm to maintain a sparse representation of the GP model. A. J. Smola and P. L. Bartlett, Sparse Greedy Gaussian Process Regression, in Advances in Neural Information Processing Systems, Volume 13, The MIT Press, 2001, proposed a forward basis vector selection method that maximizes approximate log posterior probability for building sparse GP models. Other selection methods include entropy and information gain based score optimization (M. Seeger, Bayesian Gaussian Process Models: PAC-bayesian Generalization Error Bounds and Sparse Approximations, PhD Thesis, University of Edinburgh, 2003; N. Lawrence, M. Seeger, and R. Herbrich, Fast Sparse Gaussian Process Methods: The Informative Vector Machine, In Advances in Neural Information Processing Systems, Volume 15, pages 609-616, The MIT Press, 2003; M. Seeger, C. K. I. Williams, and N. D. Lawrence, Fast Forward Selection to Speed Up Sparse Gaussian Process Regression, in C. M. Bishop and B. J. Frey, editors, Proceedings of the Ninth International Workshop on Artificial Intelligence and Statistics, San Francisco, USA, Morgan Kaufmann, 2003), marginal likelihood maximization (J. Q. Candela and C. E. Rasmussen, Analysis of Some Methods for Reduced Rank Gaussian Process Regression, R. Murray-Smith and R. Shorten, editors, Switching and Learning in Feedback Systems, Volume 3355 of Lecture Notes in Computer Science, pages 98-127, Springer, Heidelberg, Germany, 2005a) and kernel matching pursuit (S. S. Keerthi and W. Chu, A Matching Pursuit Approach to Sparse Gaussian Process Regression, In Advances in Neural Information Processing Systems, Volume 17, The MIT Press, 2005). E. Snelson and Z. Ghahramani, Sparse Gaussian Processes Using Pseudo-inputs, In Advances in Neural Information Processing Systems, Volume 18, The MIT Press, 2006, proposed to use pseudo-inputs to build sparse GP models. It is also interesting to note that relevance vector machine and subset of regressors can be thought of as sparse linear approximations to GPs (M. Tipping, Sparse Bayesian Learning and The Relevance Vector Machine, Journal of Machine Learning Research, 1:211-244, 2001; G. Wahba, X. Gao, F. Xiang, R. Klein, and B. Klein, The Bias-variance Trade-off and the Randomized GAVC, In Advances in Neural Information Processing Systems, Volume 11, The MIT Press, 1999).

In general, sparse GP methods aim at selecting an informative set of basis vectors for the predictive model. Due to memory and computational constraints, the number of basis vectors in the model is usually limited by a user defined parameter dₘₐₓ. With n>>dₘₐₓ, the sparse GP models have reduced training computational complexity of O(ndₘₐₓ²); the reduced prediction complexity is O(dₘₐₓ) and O(dₘₐₓ²) to compute the predictive mean and variance respectively. Considering the various sparse approximations that have been studied, J. Q. Candela and C. E. Rasmussen, A Unifying View of Sparse Approximate Gaussian Process Regression, Journal of Machine Learning Research, 6:1939-1959, 2005b, brought in a unifying view of sparse approximate GP regression that includes all existing proper probabilistic sparse approximations.

Unfortunately, none of the approaches mentioned above estimate predictive ability of the model by using predictive measures to build sparse GP regression models. CV based predictive measures have been successfully used in model selection in various contexts (G. C. Cawley and N. L. C. Talbot, Fast Exact Leave-one-out Cross-validation of Sparse Least Squares Support Vector Machines, Neural Networks, 17(10):1467-1475, 2004; S. Geisser, the Predictive Sample Reuse Methods with Applications, Journal of American Statistical Association, 70(35): 320-328, 1975; S. Geisser and W. F. Eddy, A Predictive Approach to Model Selection, Journal of American Statistical Association, 74(365): 153-160, 1979; M. Stone, Cross-validatory Choice and Assessment of Statistical Predictions (with discussion), Journal of Royal Statistical Society (Series B), 36:111-147, 1974; S. Sundararajan and S. S. Keerthi, Predictive Approaches for Choosing Hyperparameters in Gaussian Processes, Neural Computation, 13(5): 1103-1118, 2001; G. Wahba, X. Gao, F. Xiang, R. Klein, and B. Klein, The Bias-variance Trade-off and the Randomized GAVC, In Advances in Neural Information Processing Systems, Volume 11, The MIT Press, 1999). X. Hong, S. Chen and C. J. Harris, Fast Kernel Classifier Using Orthogonal Forward Selection to Minimise the Leave-out-one Misclassification Rate, Volume 4113 of Lecture Notes in Computer Science, pages 106-114, Springer, 2006, combined orthogonal forward selection and a LOO-CV based measure to design sparse linear kernel classifiers with Gaussian kernels. G. C. Cawley and N. L. C. Talbot, Fast Exact Leave-one-out Cross-validation of Sparse Least Squares Support Vector Machines, Neural Networks, 17(10):1467-1475, 2004, designed a LOO-CVE based sparse least squares support vector machine.

What is needed is a system and method that may estimate predictive ability of the GP regression model by using a predictive measure to build a sparse GP regression model. Such a system and method should provide a framework for using various predictive measures in building sparse GP regression models.

### SUMMARY OF THE INVENTION

Briefly, the present invention provides a system and method for sparse Gaussian process regression using predictive measures. A Gaussian process regressor model selector may be provided for constructing a Gaussian process regressor model by interleaving basis vector set selection and hyper-parameter optimization until a chosen predictive measure stabilizes, and a predictive measure engine for using a predictive measure to select a basis vector for incrementally generating an active set of basis vectors. To do so, the Gaussian process regressor model selector may generate a Gaussian process regressor model in an embodiment by using a predictive measure to incrementally select an active set of basis vectors for a fixed set of hyper-parameters and then may iteratively optimize the hyper-parameters using the chosen predictive measure and regenerate the active sets of basis vectors by using a predictive measure to incrementally select an active set of basis vectors for the optimized set of hyper-parameters at each iteration until a stopping criterion may be met.

The present invention may use one of the various LOO-CV based predictive measures namely, LOO-CV error (LOO-CVE), Geisser's surrogate Predictive Probability (GPP) and Predictive Mean Squared Error (GPE), to find the optimal set of active basis vectors for building sparse Gaussian process regression models. The sparse Gaussian process regression model may be constructed by sequentially adding basis vectors selected using a chosen predictive measure till the predictive performance of the model improves. The basis vector to be added in a given iteration may be selected from a candidate set of basis vectors. A predictive performance score is computed for each of the basis vectors in the candidate set and the basis vector with the best score is selected. The iterative addition of basis vectors may stop when predictive performance of the model degrades or no significant performance improvement is seen. Then the hyper-parameter values for this active set of basis vectors may be optimized using a chosen predictive measure. Thus, the algorithm interleaves optimization of the hyper-parameter values and basis vector selection.

Advantageously, the present invention may support many applications for solving nonlinear regressions problems. For example, online advertising applications may use the present invention for time series prediction of web page views for placement of advertisements. Online search advertising applications may use the present invention for predicting the relevance of a page as a function of the properties of a search query and result pages to be displayed. Or online search advertising applications may use the present invention for predicting the click through rate as a function of query, ad and user. For any of these applications, the online function evaluation may be performed in real-time. Where it may also be important in these types of applications to estimate error bars associated with the predictions, Gaussian process regression may provide error bars as well as predictions.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for sparse Gaussian process regression using predictive measures, in accordance with an aspect of the present invention;

FIG. 3 is a flowchart generally representing the steps undertaken in one embodiment for constructing a sparse Gaussian process regressor model using predictive measures, in accordance with an aspect of the present invention;

FIG. 4 is a flowchart generally representing the steps undertaken in an embodiment for selecting a basis vector from a candidate set of basis vectors using a predictive measure, in accordance with an aspect of the present invention; and

FIG. 5 is a flowchart generally representing the steps undertaken in one embodiment for adding a selected basis vector to the active set of basis vectors of the sparse Gaussian process regressor model, in accordance with an aspect of the present invention.

### DETAILED DESCRIPTION

### Exemplary Operating Environment

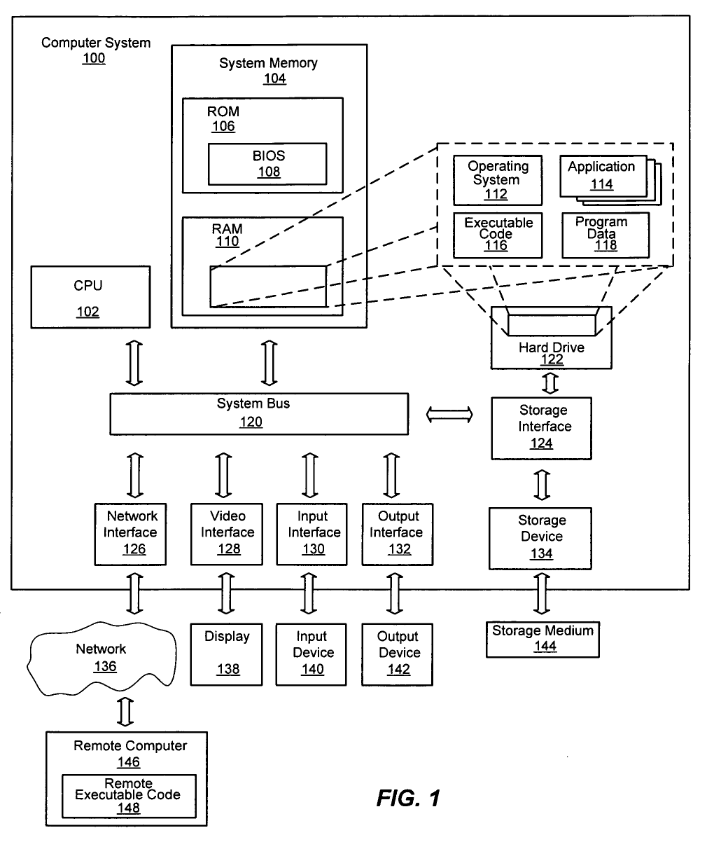

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing-the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Sparse Gaussian Process Regression Using Predictive Measures

The present invention is generally directed towards a system and method for sparse Gaussian process regression using predictive measures. Gaussian process (GP) regression models are flexible, powerful, and easy to implement probabilistic models that can be used to solve regression problems in many areas of application. The system and method of the present invention may use leave-one-out cross validation (LOO-CV) based predictive measures namely, LOO-CV error (LOO-CVE), Geisser's surrogate Predictive Probability (GPP) and Predictive Mean Squared Error (GPE) to select basis vectors for building sparse Gaussian process regression models. While the LOO-CVE measure uses only predictive mean information, the GPP and GPE measures use predictive variance information as well. The sparse model may be constructed by sequentially adding basis vectors selected using a chosen predictive measure till the predictive performance of the model improves. This may result in a sparse model with reduced complexity and very good generalization performance. Training time may be reduced by efficiently computing predictive measures as a new basis vector is added and the model is updated. An efficient cache implementation is also provided for the algorithms which gives similar or better generalization performance with lesser number of basis vectors. Moreover, each of these three LOO-CV based predictive measures can be used to find the number of basis vectors in the model automatically.

As will be seen, better predictive performance and reduced prediction time may be achieved by using the predictive performance score based selection criterion, and reduced training time may be achieved by efficient computation of the score. As will be understood, the various block diagrams, flow charts and scenarios described herein are only examples, and there are many other scenarios to which the present invention will apply.

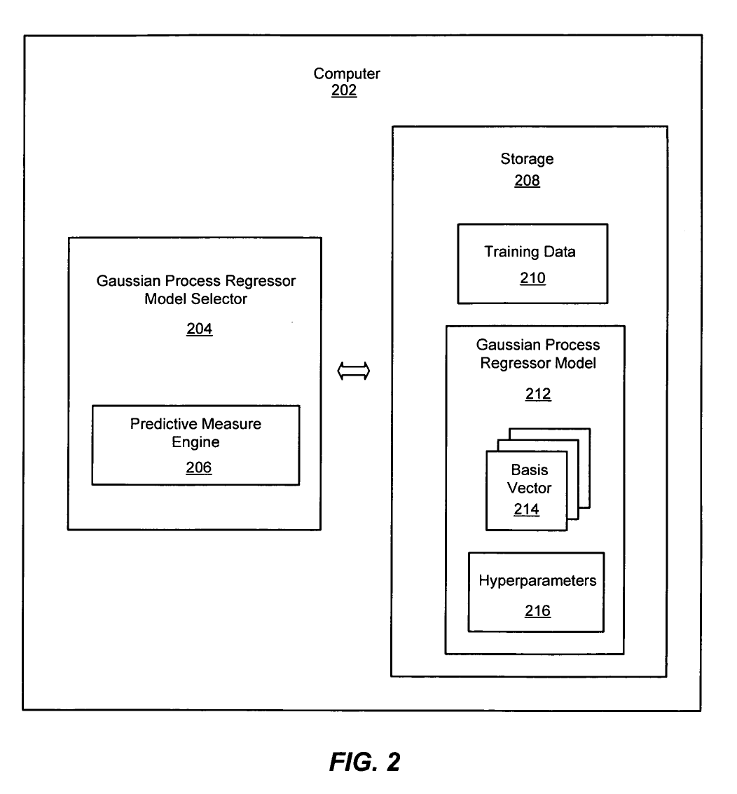

Turning to FIG. 2 of the drawings, there is shown a block diagram generally representing an exemplary architecture of system components for sparse Gaussian process regression using predictive measures. Those skilled in the art will appreciate that the functionality implemented within the blocks illustrated in the diagram may be implemented as separate components or the functionality of several or all of the blocks may be implemented within a single component. For example, the functionality for the predictive measure engine 206 may be included in the same component as the Gaussian process regressor model selector 204. Or the functionality of the predictive measure engine 206 may be implemented as a separate component from the Gaussian process regressor model selector 204.

In various embodiments, a computer 202, such as computer system 100 of FIG. 1, may include a Gaussian process regressor model selector 204 operably coupled to storage 212. In general, the Gaussian process regressor model selector 204 may be any type of executable software code such as a kernel component, an application program, a linked library, an object with methods, and so forth. The storage 208 may be any type of computer-readable media and may store training data 210, and a Gaussian process regressor model 212 that may include a set of basis vectors 214 and a set of hyper-parameters 216.

The Gaussian process regressor model selector 204 may generate a Gaussian process regressor model by iteratively optimizing hyper-parameters for regenerated active sets of basis vectors until the chosen predictive measure stabilizes. The Gaussian process regressor model selector 204 may include a predictive measure engine for using a predictive measure to select a basis vector for incrementally generating an active set by adding a basis vector at a time. Each of these modules may also be any type of executable software code such as a kernel component, an application program, a linked library, an object with methods, or other type of executable software code. The Gaussian process regressor model selector 204 may generate a Gaussian process regressor model by using a predictive measure to incrementally select an active set of basis vectors for a fixed set of hyper-parameters and then may iteratively optimize the hyper-parameters and regenerate the active sets of basis vectors by using a predictive measure to incrementally select an active set of basis vectors for the optimized set of hyper-parameters at each iteration until the chosen predictive measure stabilizes.

There are many applications which may use the present invention for solving nonlinear regressions problems. For example, online advertising applications may use the present invention for time series prediction of web page views for placement of advertisements. Online search advertising applications may use the present invention for predicting the relevance of a page as a function of the properties of a search query and result pages to be displayed. Or online search advertising applications may use the present invention for predicting the click through rate as a function of query, ad and user. For any of these applications, the online function evaluation may be performed in real-time. It may also be important in these types of applications to estimate error bars associated with the predictions. In addition to provide predictions, Gaussian processes form a very important class of modern nonlinear regression methods with the ability to provide error bars as well as predictions.

A sparse Gaussian Process predictive model may be constructed using training examples. A training data set may be represented by n input-output pairs (xᵢ,yᵢ) where xᵢ ∈ R^{D}, yᵢ ∈ R, i ∈ Ĩ and Ĩ={1, 2, . . . , n}. The true function value at xᵢ is represented as a latent variable ƒ(xᵢ) and the target yᵢ(=ƒ(xᵢ)+εᵢ) is a noisy measurement of ƒ(xᵢ). The goal is to compute the predictive distribution of the function values ƒ* (or noisy y*) at test location x*. In standard GPs for regression (see C. E. Rasmussen and C. K. I. Williams, Gaussian Processes for Machine Learning, The MIT Press, 2006), the latent variables ƒ(xᵢ) are modeled as random variables in a zero mean GP indexed by {xᵢ}. The prior distribution of {f(Xₙ)} is a zero mean multivariate joint Gaussian, denoted as p(f)=N(0,K_{f,f}), where f=[ƒ(x₁), . . . , ƒ(xₙ)]^{T}, Xₙ=[x₁, . . . , xₙ] and K_{f,f} is the n×n covariance matrix whose (i,j)^{th} element is k(xᵢ,xⱼ) and is often denoted as K_{i,j}. One of the most commonly used covariance function is the squared exponential covariance function given by:

$$cov ( f ( {x}_{i} ) , f ( {x}_{j} ) = k ( {x}_{i} , {x}_{j} ) = {β}_{0} exp ( - \frac{1}{2} {\sum }_{k = 1}^{D} \frac{{( {x}_{i , k} - {x}_{j , k} )}^{2}}{{β}_{k}} ) .$$

Here, β₀ represents signal variance and the βₖ×s represent width parameters across different input dimensions. These parameters are also known as automatic relevance determination (ARD) hyper-parameters. This covariance function is known as the ARD Gaussian kernel function. Now, given the prior the likelihood is a model of additive measurement noise εᵢ where i ∈ Ĩ, which is modeled as p(y|f)=N(f,σ²I), where y=[y₁, . . . , yₙ]^{T} and σ² is the noise variance. These models with the hyperparameters θ=[β₀,β₁, . . . , β_{D},σ²] characterize the GP model. These hyperparameters can be either estimated from the dataset, or can be integrated out using Markov Chain Monte Carlo methods in full Bayesian solution. Using standard Bayesian rule, inference is made for x* from the posterior predictive distribution: p(ƒ*|y)=N(K*_{,f}(K_{f,f}+σ²I)⁻¹y,K*_{,}*−K*_{,ƒ}(K_{f,f}+σ²I)⁻¹K_{f,}*).

J. Q. Candela and C. E. Rasmussen, A Unifying View of Sparse Approximate Gaussian Process Regression, Journal of Machine Learning Research, 6:1939-1959, 2005b noted that by approximating the joint prior p(f,ƒ*) to q(f,ƒ*)=∫q(ƒ*|u)q(f|u)p(u)du with additional assumptions about the two approximate inducing conditionals q(f|u) and q(f*|u) almost all probabilistic sparse GP approximations are obtained with exact inference. Here u denotes an additional set of m latent variables u=[u₁, . . . , uₘ]^{T} which are called inducing variables; these latent variables are values of GP like f, corresponding to a set of input locations Xᵤ, referred to as inducing inputs and are commonly known as basis vectors or active set. In the context of predictive approaches, the resultant posterior predictive distributions corresponding to these approximations are of interest and some of them that are useful are next discussed.

A likelihood approximation proposed by E. Snelson and Z. Ghahramani, Sparse Gaussian Processes Using Pseudo-inputs, In Advances in Neural Information Processing Systems, Volume 18, The MIT Press, 2006, which is termed as the Fully Independent Training Conditional (FITC) approximation ( see J. Q. Candela and C. E. Rasmussen, A Unifying View of Sparse Approximate Gaussian Process Regression, Journal of Machine Learning Research, 6:1939-1959, 2005b) results in the posterior predictive distribution: q_{FITC}(ƒ*,y,Xᵤ,θ)=N(\hat{ƒ}(x*),σ*²), where the predictive mean and variance are given by \hat{ƒ}(x*)=K*_{,u}α and σ*²=K*_{,}*−Q*_{,}*+K*_{,u}ΣK_{u,}*. Here α=ΣK_{u,f}Λ⁻¹y and Σ=(K_{u,f}Λ⁻¹K_{f,u}+K_{u,u})⁻¹ and Λ=diag[K_{f,f}−Q_{f,f}+σ²I); further Q*_{,}* and Q_{f,f} are defined with the convention Q_{a,b}=K_{a,u}K_{u,u}⁻¹K_{u,b}. Note that the Deterministic Training Conditional (DTC) approximation corresponding to the likelihood approximation proposed by M. Seeger, C. K. I. Williams, and N. D. Lawrence, Fast Forward Selection to Speed Up Sparse Gaussian Process Regression, in C. M. Bishop and B. J. Frey, editors, Proceedings of the Ninth International Workshop on Artificial Intelligence and Statistics, San Francisco, USA, Morgan Kaufmann, 2003 and the subset of regressors (SoR) approximation (see B. W. Silverman, Some Aspects of the Spline Smoothing Approach to Non-parametric Regression Curve Fitting (with discussion), Journal of Royal Statistical Society (Series B), 47(1):1-52, 1985; and G. Wahba, X. Gao, F. Xiang, R. Klein, and B. Klein, The Bias-variance Trade-off and the Randomized GAVC, In Advances in Neural Information Processing Systems, Volume 11, The MIT Press, 1999) result in similar expressions, except that in the cases of DTC and SoR approximations, Λ=σ²I; further in the case of SoR approximation the predictive variance is only K*_{,u}ΣK_{u,}*. Note that the posterior predictive distribution is dependent on the inducing inputs Xᵤ; therefore, the choice of Xᵤ is very important in achieving good generalization performance. Similar to the posterior predictive distributions, the marginal likelihood can be obtained for the different effective priors and its negative logarithmic form is given by:

$$q ( y \vert {X}_{u} , θ ) = \frac{1}{2} {{y}^{T} ( {Q}_{f , f} + Λ )}^{- 1} y + \frac{1}{2} log \vert {Q}_{f , f} + Λ \vert + \frac{n}{2} log ( 2 π ) .$$

As earlier in the cases of SoR and DTC approximations, λ=σ²I.

In sparse GPs, the basis vectors are chosen from the training instances or test instances in a transduction setup (see A. Schwaighofer and V. Tresp, Transductive and Inductive Methods for Approximate Gaussian Process Regression, In Advances in Neural Information Processing Systems, Volume 15, The MIT Press, 2003) or as pseudo-inputs in a continuous optimization setup (see E. Snelson and Z. Ghahramani, Sparse Gaussian Processes Using Pseudo-inputs, In Advances in Neural Information Processing Systems, Volume 18, The MIT Press, 2006). To reduce computational burden, the basis vectors are selected in a greedy fashion with suitably defined measure. For example, A. J. Smola and P. L. Bartlett, Sparse Greedy Gaussian Process Regression, in Advances in Neural Information Processing Systems, Volume 13, The MIT Press, 2001, proposed to select the basis vector that minimizes the negative logarithm of an approximate posterior probability (NLPP); J. Q. Candela and C. E. Rasmussen, Analysis of Some Methods for Reduced Rank Gaussian Process Regression, R. Murray-Smith and R. Shorten, editors, Switching and Learning in Feedback Systems, Volume 3355 of Lecture Notes in Computer Science, pages 98-127, Springer, Heidelberg, Germany, 2005a suggested to minimize negative logarithm of marginal likelihood (NLML) with the DTC approximation and made comparison with the NLPP algorithm. However, none of these approaches estimate predictive ability of the model by using predictive measures to build sparse GP regression models. The GPP and GPE predictive measures take the predictive variance information into account. Though entropy and information gain score criteria use predictive variance (see M. Seeger, C. K. I. Williams, and N. D. Lawrence, Fast Forward Selection to Speed Up Sparse Gaussian Process Regression, in C. M. Bishop and B. J. Frey, editors, Proceedings of the Ninth International Workshop on Artificial Intelligence and Statistics, San Francisco, USA, Morgan Kaufmann, 2003; N. Lawrence, M. Seeger, and R. Herbrich, Fast Sparse Gaussian Process Methods: The Informative Vector Machine, In Advances in Neural Information Processing Systems, Volume 15, pages 609-616, The MIT Press, 2003) make approximations which result in O(1) score computation per sample. Such approximations may affect the generalization performance for a given number of basis vectors, as was observed in S. S. Keerthi and W. Chu, A Matching Pursuit Approach to Sparse Gaussian Process Regression, In Advances in Neural Information Processing Systems, Volume 17, The MIT Press, 2005. Further, this may result in increasing the number of basis vectors for a given generalization performance. By using predictive measures to build sparse GP regression models, the present invention may compute the predictive measures without approximation and this increases the computational cost. However, the computational complexity is same as that of the ML and approximate log posterior probability maximization approaches.

Note that the LOO-CV based predictive measures are quite generic in the sense that they can be used to select the basis vectors irrespective of whether they are selected from the training instances and/or the test instances in the transduction setup or optimized as pseudo-inputs in the continuous optimization setup mentioned earlier. However, in an illustration of an embodiment of the present invention, the implementation selects the basis vectors from the training inputs. Those skilled in the art will appreciate that other implementations may use the LOO-CV based predictive measures to select the basis vectors from the test instances in the transduction setup or optimized as pseudo-inputs in the continuous optimization setup.

In order to define the LOO-CV based predictive measures, consider q(yᵢ|y₋ᵢ,Xᵤ,θ) to denote the Gaussian posterior predictive distribution with mean \hat{f}₋ᵢ(xᵢ;u) and variance σ₋ᵢ²(xᵢ;u). Here, yᵢ denotes the i^{th} noisy measurement of ƒ(xᵢ) and y₋ᵢ denote the training set outputs with the i^{th} sample removed. Note that yᵢ is used to represent both the variable and observed noisy sample, leaving the context to explain its usage. Then, the LOO-CV based predictive measures may be defined as follows.

First of all, the LOO-CV error (LOO-CVE) may be defined as the average squared error of the predictive mean of the i^{th} sample with the predictive distribution q(yᵢ|y₋ᵢ,Xᵤ,θ) obtained from leaving out the i^{th} sample. To be specific, the LOO-CV error (LOO-CVE) may be represented by the following equation:

$$LOO - CVE ( {X}_{u} , θ ) = \frac{1}{n} {\sum }_{i = 1}^{n} {( {y}_{i} - {\hat{f}}_{- i} ( {x}_{i} ; u ) )}^{2} .$$

Note that although \hat{f}₋ᵢ(xᵢ;u) is dependent on the inducing inputs Xᵤ and hyper-parameters θ, they are suppressed for notational convenience.

Second, the negative logarithm of Geisser's surrogate predictive probability (NLGPP) measure is defined (see S. Geisser, the Predictive Sample Reuse Methods with Applications, Journal of American Statistical Association, 70(35): 320-328, 1975; S. Sundararajan and S. S. Keerthi, Predictive Approaches for Choosing Hyperparameters in Gaussian Processes, Neural Computation, 13(5): 1103-1118, 2001) as:

$$N L G P P ( {X}_{u} , θ ) = - \frac{1}{n} {\sum }_{i = 1}^{n} log q ( {y}_{i} \vert {y}_{- i} , {X}_{u} , θ ) ,$$

and it can be written within some constant as:

$$N L G P P ( {X}_{u} , θ ) = \frac{1}{n} {\sum }_{i = 1}^{n} \frac{{( {y}_{i} - {\hat{f}}_{- i} ( {x}_{i} ; u ) )}^{2}}{{σ}_{- i}^{2} ( {x}_{i} ; u )} + log ( {σ}_{- i}^{2} ( {x}_{i} ; u ) ) .$$

On comparing the equation

$$LOO - CVE ( {X}_{u} , θ ) = \frac{1}{n} {\sum }_{i = 1}^{n} {( {y}_{i} - {\hat{f}}_{- i} ( {x}_{i} ; u ) )}^{2} .$$

and the equation note

$$NLGPP ( {X}_{u} , θ ) = \frac{1}{n} {\sum }_{i = 1}^{n} \frac{{( {y}_{i} - {\hat{f}}_{- i} ( {x}_{i} ; u ) )}^{2}}{{σ}_{- i}^{2} ( {x}_{i} ; u )} + log ( {σ}_{- i}^{2} ( {x}_{i} ; u ) ) ,$$

note that the LOO-CVE may take only the predictive mean into account, while the NLGPP may take the predictive variance also into account.

Third, Geisser's surrogate predictive mean squared error (GPE) is defined (see S. Sundararajan and S. S. Keerthi, Predictive Approaches for Choosing Hyperparameters in Gaussian Processes, Neural Computation, 13(5): 1103-1118, 2001) as

$$GPE ( {X}_{u} , θ ) = \frac{1}{n} {\sum }_{i = 1}^{n} {E ( {y}_{i} - {t}_{i} )}^{2} ,$$

where yᵢ is the observed output and tᵢ is a random variable and the expectation operation is defined with respect to q(tᵢ|y₋ᵢ,Xᵤ,θ). Then the GPE measure can be represented by the following equation:

$$GPE ( {X}_{u} , θ ) = \frac{1}{n} {\sum }_{i = 1}^{n} {( {y}_{i} - {\hat{f}}_{- i} ( {x}_{i} ; u ) )}^{2} + {σ}_{- i}^{2} ( {x}_{i} ; u ) .$$

Note that the first term is nothing but LOO-CVE and the second term comes from uncertainty associated with the predictions. On comparing

$$NLGPP ( {X}_{u} , θ ) = \frac{1}{n} {\sum }_{i = 1}^{n} \frac{{( {y}_{i} - {\hat{f}}_{- i} ( {x}_{i} ; u ) )}^{2}}{{σ}_{- i}^{2} ( {x}_{i} ; u )} + log ( {σ}_{- i}^{2} ( {x}_{i} ; u ) )$$

and

$$GPE ( {X}_{u} , θ ) = \frac{1}{n} {\sum }_{i = 1}^{n} {( {y}_{i} - {\hat{f}}_{- i} ( {x}_{i} ; u ) )}^{2} + {σ}_{- i}^{2} ( {x}_{i} ; u ) ,$$

note that the predictive variance in GPE is additive in nature compared to the NLGPP measure where the predictive variance interacts in a nonlinear fashion.

The GP regression model may be represented by a set of basis vectors, known as an active set, and associated hyper-parameters. The performance of a given model is dependent on both the active set of basis vectors and the associated hyper-parameters. The basis vectors and values of the hyper-parameters are chosen using the training examples. The choice of training inputs as the inducing inputs is motivated by the fact that they are often representative of the input distribution. While using the subset of training inputs as the inducing inputs, a subtle point is that the (Xᵤyᵤ) pairs may not be strictly left in the LOO-CV measures given above; this is because the summation is defined over all the samples. However, this is not a limitation since only Xᵤ may be used for the inducing inputs and not yᵤ, while predicting those outputs; also, those samples may be left in the summation as there are a large number of samples and n>>dₘₐₓ.

Considering for example the FITC posterior predictive distribution, the LOO predictive mean \hat{f}₋ᵢ(xᵢ;u) and variance σ₋ᵢ²(xᵢ;u) are given by: \hat{ƒ}₋ᵢ(xᵢ;u)=K_{i,u}Σ₋ᵢK_{u,-i}Λ₋ᵢ⁻¹y₋ᵢ and σ₋ᵢ²(xᵢ;u)=K_{i,i}−Q_{i,i}+K_{i,u}Σ₋ᵢK_{u,-i} where Σ₋ᵢ=(K_{u,-i}Λ₋ᵢ⁻¹K_{-i,u}+K_{u,u})⁻¹ and Q_{i,i}=K_{i,u}K_{u,u}⁻¹K_{u,i}. Here, K_{u,-i} is nothing but K_{u,f} with the i^{th} column removed. Similarly, Λ₋ᵢ denotes Λ with i^{th} column and row removed. Note that in the case of a noisy sample, the predictive variance contains σ² additionally. In an illustration of an embodiment of the present invention, the implementation may consider q_{FITC}(ƒ*,y,Xᵤ,θ)=N(\hat{ƒ}(x*),σ*²) with Λ=σ²I, that is, the DTC approximation. Those skilled in the art will appreciate that the FITC predictive distribution case can be extended in a straight forward way by considering transformed set of matrices like

$${Λ}^{- \frac{1}{2}} y and {K}_{u , f} {Λ}^{- \frac{1}{2}} .$$

In building a GP regression model, a set of active basis vectors and associated hyper-parameters may be found using the greedy selection algorithm of C. E. Rasmussen and C. K. I. Williams, Gaussian Processes for Machine Learning, The MIT Press, 2006, that is well-known in SGPR model learning. In general, the algorithm interleaves basis vector set selection and hyper-parameter optimization and continues until a stopping criterion is met. The present invention may use one of the various LOO-CV based predictive measures namely, LOO-CV error (LOO-CVE), Geisser's surrogate Predictive Probability (GPP) and Predictive Mean Squared Error (GPE), to find the optimal set of active basis vectors for building sparse Gaussian process regression models. The SGPR model may be constructed by sequentially adding basis vectors selected using a chosen predictive measure till the predictive performance of the model improves.

In an embodiment, a sparse Gaussian Process predictive model may be constructed by starting with some fixed values for the hyper-parameters and an empty active set of basis vectors. An active set of basis vectors may then be sequentially chosen for fixed hyper-parameter values by iteratively adding one basis vector at a time to the active set of basis vectors. The basis vector to be added in a given iteration may be selected from a candidate set of basis vectors. A predictive performance score is computed for each of the basis vectors in the candidate set and the basis vector selected is the one that gives the best score. The iterative addition of basis vectors stops when predictive performance of the model degrades or no significant performance improvement is seen. Then the algorithm optimizes the hyper-parameter values for this Active Set in the outer loop. Thus the algorithm interleaves optimization of the hyper-parameter values and basis vector selection. It terminates when a suitable criterion is met.

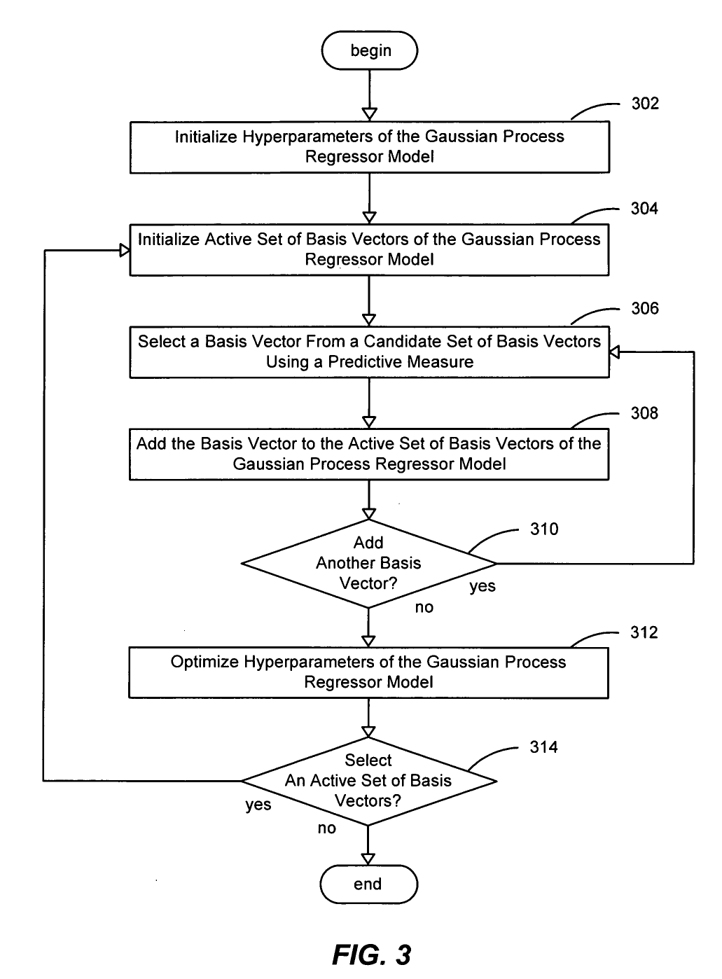

FIG. 3 presents a flowchart generally representing the steps undertaken in one embodiment for constructing a sparse Gaussian process regressor model using predictive measures. At step 302, the hyper-parameters of the sparse Gaussian process regressor model may be initialized. In an embodiment, the hyper-parameters θ may be estimated from the training data. In various other embodiments, the hyper-parameters may be integrated out of the training data using Markov Chain Monte Carlo methods in a full Bayesian solution. The active set of basis vectors of the sparse Gaussian process regressor model may be initialized at step 304. Consider u to denote the set of indices of the basis vectors in the model and consider m to denote the cardinality of this set. In an embodiment, the active set of basis vectors may be initialized to the empty set, Xᵤ=φ. Consider A to denote the indices that may be chosen from the basis set of vectors. Then A may also be initialized to the empty set, A=φ. Finally, consider R to denote the set of indices of remaining basis vectors where R may be initialized to the full set of indices of basis vectors, R={1, 2, . . . , n}.

At step 306, a basis vector may be selected from a candidate set of basis vectors using a predictive measure. In an embodiment, a candidate set of basis vectors, J ⊂ R, may be created and a predictive measure may be computed for all j ∈ J, M(X_{ūj},θ). An index l may be selected for one basis vector using the predictive measure, for instance by finding the minimum value of the predictive measure computed for all j,

$$l = {\text{arg} min}_{j ∈ J} M ( {X}_{{\overline{u}}_{j}} , θ ) .$$

In various embodiments, one of the LOO-CV based predictive measures namely, LOO-CVE, GPP, and GPE, may be be used to select the basis vector to add to the optimal set of active basis vectors for building sparse Gaussian process regression model.

Due to resource constraints like memory and computational cost requirements for choosing a basis vector, the algorithm maintains in various embodiments a set of candidate basis vectors J of fixed size K. A. J. Smola and P. L. Bartlett, Sparse Greedy Gaussian Process Regression, in Advances in Neural Information Processing Systems, Volume 13, The MIT Press, 2001, suggested to construct this set of candidate basis vectors in each iteration by randomly choosing K elements from the remaining set of training inputs R and set K to 59. Apart from the randomly chosen 59 candidate basis vectors, an implementation of the present invention may retain some of the members of the current set of candidate basis vectors in the cache. After sorting the members of the set of candidate basis vectors according to the chosen measure, the top basis vector is added to Xᵤ and the next d_{cache} basis vectors are kept in the cache. The cache implementation has the advantage that a basis vector can be chosen from a larger set of candidate basis vectors subsequently. In addition to the LOO-CVE predictive measure, the computation of the NLML and NLPP predictive measures can also benefit from the cache implementation. In the case of the NLML and NLPP predictive measures, it is not necessary to select d_{cache} basis vectors from the top, because if some of these basis vectors are very close to the best chosen basis vector in the set of candidate basis vectors, then they will have measure values similar to that of the chosen basis vector.

At step 308, a selected basis vector may be added to the active set of basis vectors of the sparse Gaussian process regressor model. In an embodiment, the selected basis vector may be added to the active set of basis vectors, Xᵤ←Xᵤ∪{xₗ}; the index l of the selected basis vector may be added to the active set of indices, A←A∪{l}; and the index l of the selected basis vector may be removed from the set of indices of remaining basis vectors, R←R\{l}.

At step 310, it may be determined whether to add another basis vector to the active set of basis vectors. In an embodiment, the iterative addition of basis vectors stops when predictive performance of the model degrades or no significant performance improvement is seen. For example, it may stop if the number of active basis vectors exceed a maximum number, dₘₐₓ. Or it may stop if the predictive performance degrades. Or it may stop if the improvement in predictive performance does not exceed a threshold. In yet another embodiment, it may stop if the predictive measures start increasing beyond the addition of an optimal number of basis vectors, dₒₚₜ. Since the predictive measures estimate the predictive ability of different models when the basis vectors are added sequentially, the predictive ability can fall-off when the model becomes more complex and starts fitting noise. Thus, the number of basis vectors needed can be automatically determined. Since dₒₚₜ is not known apriori, the user defined dₘₐₓ can still be used if there are computational constraints, and the algorithm can be terminated if dₘₐₓ basis vectors are added and dₘₐₓ≦dₒₚₜ.

If it may be determined to add another basis vector to the active set of basis vectors at step 310, then processing may continue at step 306 and a basis vector may be selected from a candidate set of basis vectors using a predictive measure. If not, then the hyper-parameters of the sparse Gaussian process regressor model may be optimized at step 312. In an embodiment, the hyper-parameters may be optimized by using the marginal likelihood maximization. In various other embodiments, the hyper-parameters may be optimized by minimizing the predictive measure.

At step 314, it may be determined whether to select another active set of basis vectors. In an embodiment, the iterative optimization of hyper-parameter stops when a suitable criterion is met, such as described in Seeger, 2003. In an embodiment, the iterative optimization of hyper-parameters may stop when the measure of improvement of the model does not exceed a threshold. If it may be determined to select another active set of basis vectors at step 314, then processing may continue at step 304 and the active set of basis vectors of the sparse Gaussian process regressor model may be initialized at step 304. If not, then processing may be finished for constructing a sparse Gaussian process regressor model using predictive measures.

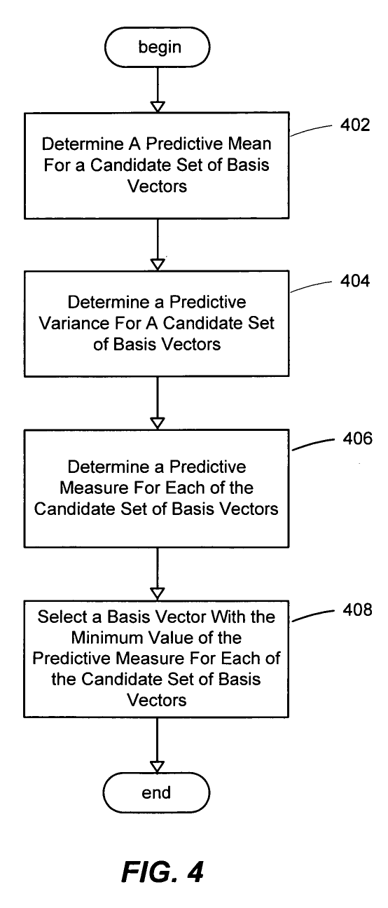

FIG. 4 presents a flowchart generally representing the steps undertaken in an embodiment for selecting a basis vector from a candidate set of basis vectors using a predictive measure. In general, the various LOO-CV based predictive measures may be computed efficiently if the predictive mean \hat{ƒ}₋ᵢ(xᵢ;u) and the predictive variance σ₋ᵢ²(xᵢ;u) for all i ∈ Ĩ given u may be computed efficiently. Accordingly, a predictive mean may be determined at step 402 for a candidate set of basis vectors, and a predictive variance may be determined at step 404 for a candidate set of basis vectors. Using the predictive mean and the predictive variance, a predictive measure, M(X_{ūj},θ), may be determined at step 406 for each of the basis vectors in the candidate set of basis vectors. Finally, a basis vector with the minimum value of the predictive measure,

$$l = {\text{arg} min}_{j ∈ J} M ( {X}_{{\overline{u}}_{j}} , θ ) ,$$

may be selected at step 408 from the candidate set of basis vectors.

In addition to efficiently computing the predictive mean \hat{ƒ}₋ᵢ(xᵢ;u) and the predictive variance σ₋ᵢ²(xᵢ;u) for all i ∈ Ĩ given u, the chosen predictive measure needs to be efficiently evaluated as a new basis vector is added to u. To do so, the algorithm may take advantage of rank one update and single basis vector addition to the matrices Σ and K_{u,u}. In practice, working with Cholesky decomposition of these matrices provides both numerical stability and computational advantages.

Recall that the predictive mean and variance using the DTC approximation are given by \hat{ƒ}(xᵢ;u)=σ⁻²K_{i,u}K_{u,f}y and \hat{σ}²(xᵢ;u)=K_{i,i}−Q_{i,i}(u)+K_{i,u}ΣK_{u,i} where Σ=(K_{u,u}+σ⁻²K_{u,f}+K_{f,u})⁻¹ and Q_{i,i}(u)=K_{i,u}K_{u,u}⁻¹K_{u,i}. Here u denote the set of indices of the basis vectors in the present model and consider m to denote the cardinality of this set. Using the same approximation, the LOO predictive mean is given by \hat{ƒ}₋ᵢ(xᵢ;u)=σ⁻²K^{i,u}Σ₋ᵢK_{u,-i}y₋ᵢ, and the LOO predictive variance is given by \hat{σ}₋ᵢ²(xᵢ;u)=K_{i,i}−Q_{i,i}(u)+K_{i,u}Σ₋ᵢK^{u,i}. Note that

$${y}_{i} - {\hat{f}}_{- i} ( {x}_{i} ; u ) = \frac{{y}_{i} - \hat{f} ( {x}_{i} ; u )}{1 - {η}_{i} ( u )}$$

$$and$$

$${\hat{σ}}_{- i}^{2} ( {x}_{i} ; u ) = {K}_{i , i} - {Q}_{i , i} ( u ) + \frac{{σ}^{2}}{1 - {η}_{i} ( u )}$$

where ηᵢ(u)=σ⁻²K_{i,u}ΣK_{u,i}. Thus, it is easy to calculate predictive measures for

$$LOO - CVE ( {X}_{u} , θ ) = \frac{1}{n} {\sum }_{i = 1}^{n} {( {y}_{i} - {\hat{f}}_{- i} ( {x}_{i} ; u ) )}^{2} ,$$

$$NLGPP ( {X}_{u} , θ ) = \frac{1}{n} {\sum }_{i = 1}^{n} \frac{{( {y}_{i} - {\hat{f}}_{- i} ( {x}_{i} ; u ) )}^{2}}{{σ}_{- i}^{2} ( {x}_{i} ; u )} + log ( {σ}_{- i}^{2} ( {x}_{i} ; u ) ) , \\ and$$

$$GPE ( {X}_{u} , θ ) = \frac{1}{n} {\sum }_{i = 1}^{n} {( {y}_{i} - {\hat{f}}_{- i} ( {x}_{i} ; u ) )}^{2} + {σ}_{- i}^{2} ( {x}_{i} ; u ) , \\ if {σ}^{- 2} ,$$

Σ and K_{i,u}, \hat{ƒ}(xᵢ;u), ηᵢ(u) and Q_{i,i}(u) for every i are available for the basis vector set u.

Initially, when m is one, all these quantities are easy to compute. Now, consider ūⱼ to denote the basis vector set when a new basis vector uⱼ is added to the set u, where ūⱼ=(u,uⱼ). These quantities can be incrementally computed when uⱼ is added to the set u; this results in an efficient selection of a basis vector using a chosen predictive measure.

Assuming that the quantities σ², K_{u,f}, λᵤ, Lᵤ, Gᵤ, \hat{ƒ}(xᵢ;u), ηᵢ(u) and Q_{i,i}(u) are available, the pseudocode for the algorithm UpdatePredictiveMeasure incrementally updates the relevant quantities needed to compute a chosen predictive measure in O(mn) as a new basis vector uⱼ may be added. In the algorithm, λᵤ=σ⁻²K_{u,f}y; Lᵤ and Gᵤ represent the LU-decomposition of the matrices Σ and K_{u,u} respectively.

In an embodiment, incrementally updating the relevant quantities needed to compute a chosen predictive measure as a new basis vector uⱼ may be added may generally be implemented by the following algorithm:

Algorithm UpdatePredictiveMeasure
For all j ∈ J

1. Compute K_{f,j}.
2. bⱼ = K_{u,j} + σ⁻²K_{u,f}K_{f,j} and cⱼ = K_{j,j} + σ⁻²K_{j,f}K_{f,j}.
3. Find zⱼ by solving Lᵤzⱼ = bⱼ.
$4. {d}_{j} = \sqrt{{c}_{j} - {z}_{j}^{T} {z}_{j}} .$
5. λⱼ = σ⁻²K_{j,f}y.
6. Find wᵤ by solving Lᵤwᵤ = λᵤ.
$7. {w}_{j} = \frac{{λ}_{j} - {z}_{j}^{T} {w}_{u}}{{d}_{j}} .$
8. Find vⱼ(u) by solving Gᵤvⱼ(u) = K_{u,j}.
$9. {e}_{j} = \sqrt{{K}_{j , j} - {v}_{j}^{T} ( u ) {v}_{j} ( u )} .$

For all i = {1, 2, . . . , n}
1. Find ζᵢ(u) by solving Lᵤζᵢ(u) = K_{u,i}.
$2. {ζ}_{i , j} = \frac{{K}_{i , j} - {z}_{j}^{T} {ζ}_{i} ( u )}{{d}_{j}}$
3. ηᵢ(ūⱼ) = ηᵢ(u) + σ⁻²ζ_{i,j}²
4. \hat{f}(xᵢ; ūⱼ) = \hat{f}(xᵢ; u) + wⱼζ_{i,j}
$\begin{matrix}5. {y}_{i} - {\hat{f}}_{- i} ( {x}_{i} ; {\overline{u}}_{j} ) = \frac{{y}_{i} - \hat{f} ( {x}_{i} ; u )}{1 - {η}_{i} ( u )} \\ 6. {v}_{i , j} = \frac{{K}_{j , i} - {v}_{j}^{T} ( u ) {v}_{i} ( u )}{{e}_{j}}\end{matrix}$
7. Q_{i,i}(ūⱼ) = Q_{i,i}(u) + v_{i,j}²
8. \hat{σ}₋ᵢ²(xᵢ; ūⱼ) = K_{i,i} − Q_{i,i}(ūⱼ) + σ⁻²(1 − ηᵢ(ūⱼ))⁻¹
end

end

In this embodiment for incrementally updating the relevant quantities needed to compute a chosen predictive measure as a new basis vector uⱼ may be added, a chosen predictive measure may be computed using the quantity

$${y}_{i} = {\hat{f}}_{- i} ( {x}_{i} ; {\overline{u}}_{j} ) = \frac{{y}_{i} - \hat{f} ( {x}_{i} ; u )}{1 - {η}_{i} ( u )}$$

calculated for the LOO predictive mean and the quantity \hat{σ}₋ᵢ²(xᵢ;ūⱼ)=K_{i,i}−Q_{i,i}(ūⱼ)+σ⁻²(1−ηᵢ(ūⱼ))⁻¹ calculated for the LOO predictive variance in the UpdatePredictiveMeasure algorithm. Using these quantities, it is easy to calculate predictive measures for

$$LOO - CVE ( {X}_{u} , θ ) = \frac{1}{n} {\sum }_{i = 1}^{n} {( {y}_{i} - {\hat{f}}_{- i} ( {x}_{i} ; {\overline{u}}_{j} ) )}^{2} , \\ NLGPP ( {X}_{u} , θ ) = \frac{1}{n} {\sum }_{i = 1}^{n} \frac{{( {y}_{i} - {\hat{f}}_{- i} ( {x}_{i} ; {\overline{u}}_{j} ) )}^{2}}{{σ}_{- i}^{2} ( {x}_{i} ; {\overline{u}}_{j} )} + log ( {σ}_{- i}^{2} ( {x}_{i} ; {\overline{u}}_{j} ) ) , \\ and$$

$$GPE ( {X}_{u} , θ ) = \frac{1}{n} {\sum }_{i = 1}^{n} {( {y}_{i} - {\hat{f}}_{- i} ( {x}_{i} ; {\overline{u}}_{j} ) )}^{2} + {σ}_{- i}^{2} ( {x}_{i} ; {\overline{u}}_{j} ) .$$

It is a good idea to store ξᵢ(u), wᵤ and vᵢ(u) so that the above calculations may be performed in O(mn) time for all the training set samples. Note that the computation of ξ_{i,j} for a given j ∈ J and for all training samples requires O(mn+m²) computational effort, which is O(mn) if n>>m. For a given j ∈ J, wⱼ can be computed in O(n) time and v_{i,j} for all the training set samples can be calculated in O(mn) time. In the case of GPE measure,

$$GPE ( {X}_{u} , θ ) = \frac{1}{n} {\sum }_{i = 1}^{n} {( {y}_{i} - {\hat{f}}_{- i} ( {x}_{i} ; {\overline{u}}_{j} ) )}^{2} + {σ}_{- i}^{2} ( {x}_{i} ; {\overline{u}}_{j} ) ,$$

it is enough to compute Σᵢ\hat{σ}₋ᵢ²(xᵢ;ūⱼ) rather than the individual \hat{σ}₋ᵢ²(xᵢ;ūⱼ). With Eᵤ=Gᵤ⁻¹Lᵤ, we have Q(u)=σ²trace(EᵤEᵤ^{T})−σ²m. This quantity is easy to compute and needs O(m²) effort.

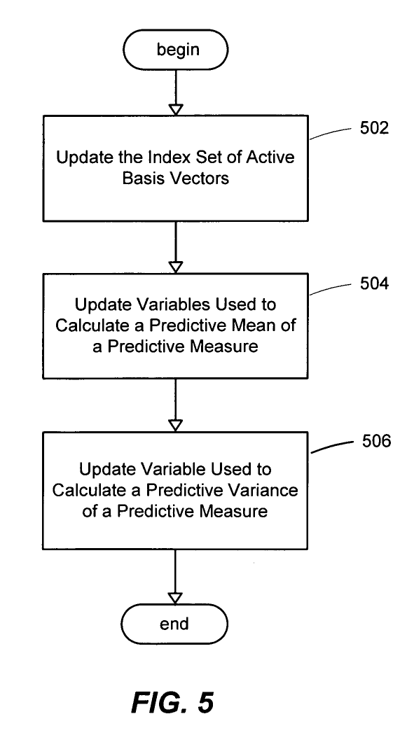

FIG. 5 presents a flowchart generally representing the steps undertaken in an embodiment for adding a selected basis vector to the active set of basis vectors of the sparse Gaussian process regressor model. At step 502, the index set of active basis vectors may be updated, such that u=(u uₗ). Updates of variable used to calculate a predictive mean and a predictive variance of a predictive measure may also be performed at this time in preparation of calculating a predictive measure during the next iteration of selecting a basis vector from the candidate set of basis vectors. Accordingly, variables used to calculate a predictive mean of a predictive measure may be updated at step 504, and variables used to calculate a predictive variance of a predictive measure may be updated at step 506.

In an embodiment, updating the index set of active basis vectors and variables of the model needed to compute a chosen predictive measure may generally be implemented by the following algorithm:

Algorithm UpdateModel

| | |
|---|---|
| 1. | u = (u uₗ). |
| 2. | ${K}_{u , f} = ( \begin{matrix}{K}_{u , f} \\ {K}_{l , f}\end{matrix} ) .$ |
| 3. | ${L}_{u} = ( \begin{matrix}{L}_{u} & 0 \\ {z}_{l}^{T} & {d}_{l}\end{matrix} ) .$ |
| 4. | ${ζ}_{i} ( u ) = ( \begin{matrix}{ζ}_{i} ( u ) \\ {ζ}_{i , l}\end{matrix} ) .$ |
| 5. | ηᵢ(u) = ηᵢ(u) + σ⁻²ζ_{i,l}². |
| 6. | ${λ}_{u} = ( \begin{matrix}{λ}_{u} \\ {λ}_{l}\end{matrix} ) .$ |
| 7. | ${w}_{u} = ( \begin{matrix}{w}_{u} \\ {w}_{l}\end{matrix} ) .$ |
| 8. | \hat{f}(xᵢ; u) = \hat{f}(xᵢ; u) + wₗζ_{i,l} |
| 9. | ${G}_{u} = ( \begin{matrix}{G}_{u} & 0 \\ {v}_{l}^{T} & {e}_{l}\end{matrix} )$ |
| 10. | ${v}_{i} ( u ) = ( \begin{matrix}{v}_{i} ( u ) \\ {v}_{i , l}\end{matrix} )$ |
| 11. | Q_{i,i}(u) = Q_{i,i}(u) + v_{i,l}². |

Note that the dimension of some of these variables increases by one after they are updated. The necessary updates of the variables K_{u,u}, Lᵤ, Gᵤ, ξᵢ(u), νᵢ(u), and wᵤ can be done easily if the relevant variables like zₗ, dₗ, eₗ, wₗ, ξ_{i,l} and ν_{i,l} are available in memory. Once an index to a basis vector 1 is selected, it is a good idea to store zⱼ for some of the existing set of candidate basis vectors in the cache (if some additional memory is available). Computation of ξ_{i,j} will then require the computation of z_{j,l} and dⱼ only, if the remaining elements of zⱼ (with respect to u) are already stored in the cache memory. Following the similar steps, computation of Q_{i,i}(ūⱼ) can be done efficiently in O(n) cost instead of O(nm) costs. The worst case storage and computational complexities for the steps of the present invention are O(ndₘₐₓ) and O(kndₘₐₓ²) respectively. Additional memory of size O(nd_{cache}) and computational cost of O(nd_{cache}dₘₐₓ) are needed for cache implementation. The various LOO-CV based predictive measures, including the NLML and NLPP, have the same computational and storage complexities.

Thus the present invention may efficiently use the LOO-CV based predictive measures to select basis vectors for building sparse GP regression (SGPR) models. In particular, the LOO-CV based predictive measures may include the LOO-CV error (LOO-CVE), Geisser's surrogate Predictive Probability (GPP) and Predictive Mean Squared Error (GPE) measures. These measures are quite generic. The importance of these measures lies in the fact that they estimate the predictive ability of the model and, the GPP and GPE measures make use of the predictive variance information as well. Training time is reduced by efficiently computing the predictive measures as new basis vector is added and model is updated. The computational complexity is same as that of the marginal likelihood (ML) and approximate log posterior probability maximization approaches. Like the ML approach, the use of predictive measures has the advantage that the number of basis vectors in the model can be automatically determined. Moreoever, an efficient cache implementation allows selection of the basis vectors from a larger set of candidate basis vectors and gives similar or better generalization performance with a lesser number of basis vectors than the ML approach.

As can be seen from the foregoing detailed description, the present invention provides an improved system and method for sparse Gaussian process regression using predictive measures. A Gaussian process regressor model may be constructed by interleaving basis vector set selection and hyper-parameter optimization until the hyper-parameters stabilize. One of various LOO-CV based predictive measures may be used to find an optimal set of active basis vectors for building a sparse Gaussian process regression model by sequentially adding basis vectors selected using a chosen predictive measure. Advantageously, the present invention may estimate predictive ability of the model by using predictive measures to build the SGPR model. Such a system and method may support many applications for solving nonlinear regressions problems. As a result, the system and method provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for using Gaussian process regression, comprising:
a sparse Gaussian process regressor model constructed using a predictive measure for incrementally selecting a plurality of basis vectors for a plurality of optimized hyper-parameters; and
a storage operably coupled to the sparse Gaussian process regressor model for storing the plurality of basis vectors and the plurality of optimized hyper-parameters.

2. The system of claim 1 further comprising a Gaussian process regressor model selector operably coupled to the storage for constructing the sparse Gaussian process regressor model by iteratively re-estimating the plurality of optimized hyper-parameters for a newly generated plurality of basis vectors.

3. The system of claim 1 further comprising a predictive measure engine operably coupled to the Gaussian process regressor model selector for using the predictive measure for incrementally selecting the plurality of basis vectors for the plurality of optimized hyper-parameters.

4. A computer-readable medium having computer-executable components comprising the system of claim 1.

5. A computer-implemented method for Gaussian process regression, comprising:
initializing a plurality of hyper-parameters for a Gaussian process regressor model;
initializing an active set of a plurality of basis vectors for the Gaussian process regressor model;
incrementally selecting a plurality of basis vectors using a predictive measure to add to the active set of the plurality of basis vectors for the Gaussian process regressor model;
optimizing the plurality of hyper-parameters for the active set of the plurality of basis vectors for the Gaussian process regressor model;
outputting the plurality of hyper-parameters for the Gaussian process regressor model and the active set of the plurality of basis vectors for the Gaussian process regressor model.

6. The method of claim 5 further comprising:
determining to select another active set of a plurality of basis vectors for the Gaussian process regressor model;
incrementally selecting a plurality of basis vectors using the predictive measure to add to the another active set of the plurality of basis vectors for the Gaussian process regressor model; and
optimizing the plurality of hyper-parameters for the another active set of the plurality of basis vectors for the Gaussian process regressor model.

7. The method of claim 5 wherein incrementally selecting the plurality of basis vectors using the predictive measure to add to the active set of the plurality of basis vectors for the Gaussian process regressor model comprises:
determining to select another basis vector using the predictive measure to add to the active set of the plurality of basis vectors for the Gaussian process regressor model;
selecting the another basis vector using the predictive measure to add to the active set of the plurality of basis vectors for the Gaussian process regressor model; and
adding the basis vector selected using the predictive measure to the active set of the plurality of basis vectors for the Gaussian process regressor model.

8. The method of claim 7 wherein determining to select another basis vector using the predictive measure to add to the active set of the plurality of basis vectors for the Gaussian process regressor model comprises determining whether the number of the plurality of basis vectors in the active set is greater than a maximum number of basis vectors.

9. The method of claim 7 wherein determining to select another basis vector using the predictive measure to add to the active set of the plurality of basis vectors for the Gaussian process regressor model comprises comparing the predictive measure to a previous value of the predictive measure.

10. The method of claim 6 wherein determining to select another active set of a plurality of basis vectors for the Gaussian process regressor model comprises determining whether a measure of improvement of the model is greater than a threshold.

11. The method of claim 5 wherein incrementally selecting a plurality of basis vectors using the predictive measure to add to the another active set of the plurality of basis vectors for the Gaussian process regressor model comprises using a LOO-CVE measure.

12. The method of claim 5 wherein incrementally selecting a plurality of basis vectors using the predictive measure to add to the another active set of the plurality of basis vectors for the Gaussian process regressor model comprises using a GPE measure.

13. The method of claim 5 wherein incrementally selecting a plurality of basis vectors using the predictive measure to add to the another active set of the plurality of basis vectors for the Gaussian process regressor model comprises using a GPP measure.

14. The method of claim 5 wherein incrementally selecting a plurality of basis vectors using the predictive measure to add to the another active set of the plurality of basis vectors for the Gaussian process regressor model comprises determining a predictive mean of the predictive measure for a candidate set of basis vectors.

15. The method of claim 5 wherein incrementally selecting a plurality of basis vectors using the predictive measure to add to the another active set of the plurality of basis vectors for the Gaussian process regressor model comprises determining a predictive variance of the predictive measure for a candidate set of basis vectors.

16. The method of claim 5 wherein optimizing the plurality of hyper-parameters for the active set of the plurality of basis vectors for the Gaussian process regressor model comprises re-estimating the plurality of hyper-parameters using the predictive measure for the active set of the plurality of basis vectors for the Gaussian process regressor model.

17. The method of claim 5 wherein outputting the plurality of hyper-parameters for the Gaussian process regressor model and the active set of the plurality of basis vectors for the Gaussian process regressor model comprises storing the plurality of hyper-parameters for the Gaussian process regressor model and the active set of the plurality of basis vectors for the Gaussian process regressor model in computer-readable storage.

18. A computer-readable medium having computer-executable instructions for performing the method of claim 5.

19. A computer system for using Gaussian process regression, comprising:
means for constructing a sparse Gaussian process regressor model using a predictive measure for incrementally selecting an active set of a plurality of basis vectors for a plurality of optimized hyper-parameters; and
means for outputting the sparse Gaussian process regressor model of the active set of the plurality of basis vectors and the plurality of optimized hyper-parameters.

20. The computer system of claim 19 further comprising:
means for determining to select another active set of a plurality of basis vectors for the Gaussian process regressor model;
means for incrementally selecting a plurality of basis vectors using the predictive measure to add to the another active set of the plurality of basis vectors for the Gaussian process regressor model; and
means for optimizing the plurality of hyper-parameters for the another active set of the plurality of basis vectors for the Gaussian process regressor model.
